(19) United States
(12) Patent Application Publication
(10) Pub. No.: US 2026/0261995 A1
(43) Pub. Date: Sep. 3, 2026

(54) METHOD AND APPARATUS FOR PROVIDING NEIGHBOUR CELL INFORMATION IN A WIRELESS COMMUNICATION SYSTEM

(71) Applicant: Samsung Electronics Co., Ltd., Gyeonggi-do (KR)

(72) Inventors: Jonas SEDIN, Middlesex (GB); Chadi KHIRALLAH, Middlesex (GB)

(21) Appl. No.: 19/489,491

(22) PCT Filed: Jun. 28, 2024
(86) PCT No.: PCT/KR2024/009105

§ 371 Date: Dec. 2, 2025

(30) Foreign Application Priority Data
Jul. 4, 2023 (GB) 2310263.5
May 24, 2024 (GB) 2407470.0

(51) Int. Cl. H04W 56/00; H04L 43/0811; H04W 84/06

(52) U.S. Cl. CPC H04W 56/0015; H04L 43/0811; H04W 84/06

(57) ABSTRACT

The disclosure relates to a 5G or 6G communication system for supporting a higher data transmission rate. Specifically, the disclosure related to a method, for a User Equipment (UE), for acquiring first cell information (e.g. first ephemeris information) of a first cell (e.g. a serving cell) and second cell information (e.g. second ephemeris) of one or more second cells (e.g. one or more neighbouring cells). The second cells are Non Terrestrial Network (NTN) cells. The method comprises: in response to expiry of a first timer (e.g. T317), indicating that validity of previously acquired first cell information has expired, starting a second timer (e.g. T318 or a newly defined timer); attempting to acquire the first cell information and the second cell information during the second timer period; and upon expiry of the second timer, performing a Radio Link Failure (RLF) procedure if the first cell information has not been successfully acquired, whether or not the second cell information has been successfully acquired.

### TECHNICAL FIELD

The present disclosure relates generally to wireless communication systems and, more specifically, the present disclosure relates to method and apparatus for acquiring neighbour cell information in a Non Terrestrial Network (NTN). For example, certain examples of the present disclosure provide one or more techniques for acquiring neighbour cell information in a 3rd Generation Partnership Project (3GPP) 5th Generation (5G) New Radio (NR) NTN.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to method and apparatus for providing neighbor cell information in a wireless communication system.

### Solution to Problem

In one embodiment of the present disclosure provide one or more techniques for acquiring neighbour cell information in a NTN. For example, certain examples of the present disclosure provide one or more techniques for acquiring neighbour cell information in a 3GPP 5G NR NTN. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a NG-RAN node (e.g. a base station or gNB) in the examples below may be applied to any other suitable type of entity performing RAN functions.

### BRIEF DESCRIPTION OF DRAWINGS

FIG. 1 illustrates an NTN architecture and scenario;

FIG. 2 illustrates an examples of an ephemeris synchronization operation;

FIG. 3 illustrates an exemplary technique in which the T318 is continued after SIB31 has been acquired if new SIB is signalled;

FIG. 4 illustrates an exemplary technique in which a new timer (e.g. T3XX/T319) is started to acquire SIB31 and a new SIB after T317;

FIG. 5 illustrates an exemplary technique in which a new timer (e.g. T3XX/T319) is started to acquire a new SIB;

FIG. 6 illustrates an exemplary technique including a SIB validity duration that triggers new SIB acquisition in a next occasion;

FIG. 7 illustrates an exemplary technique in which a new SIB is re-acquired in a next T318 occasion upon a failed attempt to acquire new SIB;

FIG. 8 illustrates an exemplary technique in which SIB31 is acquired autonomously and T318 is not triggered (to acquire SIB31 and new SIB);

FIG. 9 illustrates an exemplary technique for signalling UE capability to autonomously acquire SIB31 but not a new SIB;

FIG. 10 is a flow diagram of an exemplary method, for a UE, for acquiring first cell information (e.g. first ephemeris information) of a first cell (e.g. a serving cell) and second cell information (e.g. second ephemeris) of one or more second cells (e.g. one or more neighbouring cells), wherein the second cells are non terrestrial network (NTN) cells;

FIG. 11 is a block diagram of a network entity, according to embodiments of the present disclosure;

FIG. 12 illustrates a block diagram of a terminal (or a user equipment (UE)), according to embodiments of the present disclosure;

FIG. 13 illustrates a block diagram of a base station, according to embodiments of the present disclosure; and

FIG. 14 illustrates a block diagram of a network entity, according to embodiments of the present disclosure.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims. Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

The skilled person will appreciate that the techniques described herein may be used in any suitable combination.

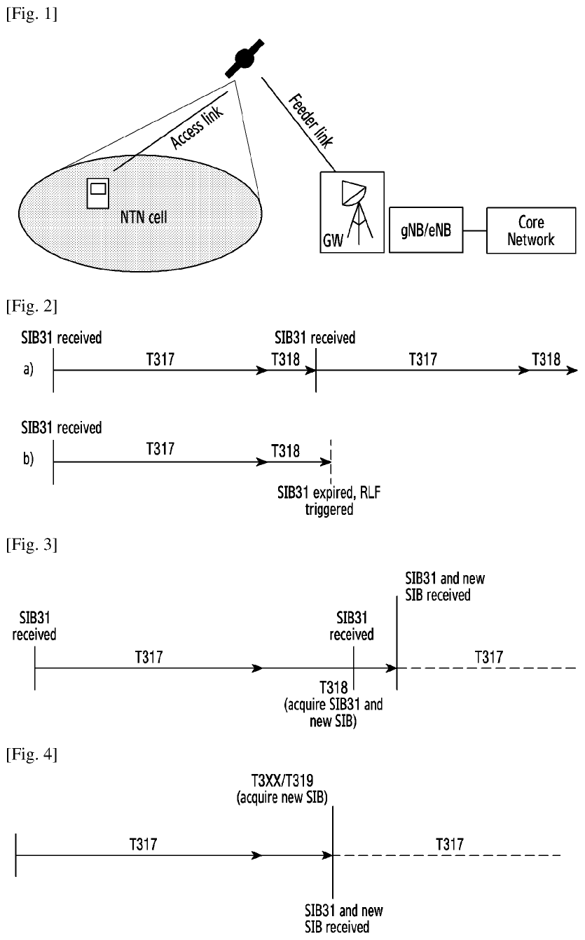

One of the areas currently under development in 3GPP 5G wireless technology is support for non-terrestrial networks (NTNs). An NTN is a network in which one or more nodes (e.g. a Next Generation Radio Access Network (NG-RAN) node) are provided by a non-terrestrial infrastructure, for example a satellite or High Altitude Platform Station (HAPS). Advantages of using an NTN include (i) extending coverage to regions, such as remote areas, with limited or no coverage from more traditional terrestrial networks, (ii) providing continuous coverage in the event of inoperability of traditional terrestrial networks, such as during natural disasters, and (iii) enhancing overall reliability, resilience and capacity when used in conjunction with existing terrestrial networks. FIG. 1 illustrates an NTN Release 17 architecture and scenario.

A satellite network implementing a network node provides coverage through one or more radio beams forming a “footprint” on the surface of the Earth defining a coverage area or cell. An NTN cell may be Earth-moving (i.e. moving over the Earth's surface according to the motion of the satellite, for example in the case of a Lower Earth Orbit (LEO) satellite), Earth-fixed (i.e. a fixed area of the Earth's surface, for example in the case of a Geosynchronous Equatorial Orbit (GEO) satellite) or quasi-Earth-fixed (i.e. a fixed area of the Earth's surface but is maintained for only a limited time as the satellite passes by).

Due to the movement of satellites in a non-stationary orbit (e.g. LEO), the cells that a UE see will be moving (i.e. Earth-moving cells). This results in frequent UE handover from one cell to another, and this handover of service will happen constantly. In view of this, mobility is one of the key issues in both NR NTN and IoT NTN.

### Overview of Internet of Things (IoT) NTN and NR NTN

IoT NTN was a 3GPP study and work item in 3GPP Release 17 (RP-202689, RAN #90 December 2020) to provide NTN access for Evolved Universal Terrestrial Radio Access Network (E-UTRAN) IoT devices (e.g. Narrowband (NB)-IoT and Long Term Evolution Machine Type Communication (LTE-M), including enhanced Machine Type Communication (eMTC)). As noted in 3GPP RP-202689, IoT operation is critical in remote areas with low/no cellular connectivity for many different industries. The capabilities of NB-IoT and eMTC are a good fit for many applications but some applications may require satellite connectivity to provide coverage beyond terrestrial deployments.

NR NTN was a work item in Release 17 to specify adaptation to allow NR to function over NTN (RP-211557, RAN #91-e March 2021).

Following the work items in Release 17 there were work items to enhance NR NTN (RP-220953, RAN #95-e March 2022) and IoT NTN (RP-220979, RAN #95-e March 2022) in Release 18.

### Overview of NB-IoT and LTE-M

NB-IoT is a 3GPP-defined network based on 4th Generation (4G) E-UTRAN that supports ultra-low complexity devices with very narrow bandwidth that was introduced in 3GPP Release 13. The use case of NB-IoT is to serve massive IoT application, where requirements for instance are to support enhanced coverage, power-efficient operation and a massive number of devices. Some of the features introduced are:
Support for enhanced coverage through low bandwidth and extreme amounts of repetitions.
Power efficient operation by allowing the User Equipment (UE) to sleep for very long times, relaxed requirements and more efficient signal to establish with a cell.

LTE-M or eMTC is a 3GPP-defined network that is an extension of 4G E-UTRAN that supports low-complexity devices with more narrow bandwidths compared to normal LTE and further simplifications of procedures. Similarly to NB-IoT, the use case is to serve massive IoT, but with more capabilities. Instead of being an entirely new type of device with major air interface changes as in NB-IoT, the LTE-M inherits most feature of a regular LTE device, but with some adaptations for low complexity considerations.

### Overview of NTN System Information

As NTN has a number of NTN-specific information elements that are only required when accessing an NTN cell, and also due to the relatively large information elements, it was agreed that new System Information Blocks (SIBs) are needed.

In NR NTN, SIB19 contains the required information to access an NTN cell:

### 3GPP TS 38.331 V17.4.0

SIB19
SIB19 contains satellite assistance information for NTN access.

SIB19 information element

-- ASN1START
-- TAG-SIB19-START
SIB19-r17 ::= SEQUENCE {

| | | |
|---|---|---|
| ntn-Config-r17 | NTN-Config-r17 | OPTIONAL, -- Need R |
| t-Service-r17 | INTEGER (0..549755813887) | OPTIONAL, -- Need R |
| referenceLocation-r17 | ReferenceLocation-r17 | OPTIONAL, -- Need R |
| distanceThresh-r17 | INTEGER(0..65525) | OPTIONAL, -- Need R |
| ntn-NeighCellConfigList-r17 | NTN-NeighCellConfigList-r17 | OPTIONAL, -- Need R |
| lateNonCriticalExtension | OCTET STRING | OPTIONAL, |

```
  ...,
  [[
```

| | | |
|---|---|---|
| ntn-NeighCellConfigListExt-v1720 | NTN-NeighCellConfigList-r17 | OPTIONAL -- Need |

R
]]
}

| | |
|---|---|
| NTN-NeighCellConfigList-r17 ::= | SEQUENCE (SIZE(1..maxCellNTN-r17)) CF NTN- |

NeighCellConfig-r17

| NTN-NeighCellConfig-r17 ::= | SEQUENCE { | |
|---|---|---|
| ntn-Config-r17 | NTN-Config-r17 | OPTIONAL, -- Need R |
| carrierFreq-r17 | ARFCN-ValueNR | OPTIONAL, -- Need R |
| physCellId-r17 | PhysCellId | OPTIONAL -- Need R |

}
-- TAG-SIB19-STOP
-- ASN1STOP

SIB19 field descriptions

distanceThresh
Distance from the serving cell reference location and is used in location-based measurement initiation in
RRC_IDLE and RRC_INACTIVE, as defined in TS 38.304 [20]. Each step represents 50 m.
ntn-Config
Provides parameters needed for the UE to access NR via NTN access such as Ephemeris data, common
TA parameters, k_offset, validity duration for UL sync information and epoch.
ntn-NeighCellConfigList, ntn-NeighCellConfigListExt
Provides a list of NTN neighbour cells including their ntn-Config, carrier frequency and PhysCellId. This set
includes all elements of ntn-NeighCellConfigList and all elements of ntn-NeighCellConfigListExt. If ntn-
Config is absent for an entry in ntn-NeighCellConfigListExt, the ntn-Config provided in the entry at the same
position in ntn-NeighCellConfigList applies. Network provides ntn-Config for the first entry of ntn-
NeighCellConfigList. If the ntn-Config is absent for any other entry in ntn-NeighCellConfigList, the ntn-
Config provided in the previous entry in ntn-NeighCellConfigList applies.
referenceLocation
Reference location of the serving cell provided via NTN quasi-Earth fixed system and is used in location-
based measurement initiation in RRC_IDLE and RRC_INACTIVE, as defined in TS 38.304 [20].
t-Service
Indicates the time information on when a cell provided via NTN quasi-Earth fixed system is going to stop
serving the area it is currently covering. The field indicates a time in multiples of 10 ms after 00:00:00 on
Gregorian calendar date 1 Jan. 1900 (midnight between Sunday, Dec. 31, 1899 and Monday,
Jan. 1, 1900). The exact stop time is between the time indicated by the value of this field minus 1 and
the time indicated by the value of this field.

### GPP TS 38.331 V17.4.0

In IoT NTN, SIB31 contains the required information to access an IoT NTN cell:

### GPP TS 36.331 V17.4.0

SystemInformationBlockType31

The IE SystemInformationBlockType31 contains satellite assistance information for the serving cell. SystemInformationBlockType31 is only signalled in a NTN cell.

SystemInformationBlockType31 information element

-- ASN1START
SystemInformationBlockType31-r17 ::= SEQUENCE {

| servingSatelliteInfo-r17 | ServingSatelliteInfo-r17, | |
|---|---|---|
| lateNonCriticalExtension | OCTET STRING | OPTIONAL, |

...
}

| | |
|---|---|
| ServingSatelliteInfo-r17 ::= | SEQUENCE { |
| ephemerisInfo-r17 | CHOICE { |
| stateVectors | EphemerisStateVectors-r17, |
| orbitalParameters | EphemerisOrbitalParameters-r17 |

},

| nta-CommonParameters-17 | SEQUENCE { | |
|---|---|---|
| nta-Common-r17 | INTEGER (0..8316827) | OPTIONAL, -- Need OP |
| nta-CommonDrift-r17 | INTEGER (−261935..261935) | OPTIONAL, -- Need OP |
| nta-CommonDriftVariation-r17 | INTEGER (0..29479) | OPTIONAL -- Need OP |

},

| | |
|---|---|
| ul-SyncValidityDuration-r17 | ENUMERATED {s5, s10, s15, s20, s25, s30, s35, s40, |
| | s45, s50, s55, s60, s120, s180, s240, |

s900},

| epochTime-r17 | SEQUENCE { | |
|---|---|---|
| startSFN-r17 | INTEGER (0..1023), | |
| startSubFrame-r17 | INTEGER (0..9) | |
| } | | OPTIONAL, -- Need OP |
| k-Offset-r17 | INTEGER (0..1023), | |
| k-Mac-r17 | INTEGER (1..512) | OPTIONAL, -- Need OP |

...
}
-- ASN1STOP

SystemInformationBlockType31 field descriptions

epochTime
Epoch time of the satellite ephemeris data and common TA parameters, see TS 36.213 [23]. The reference
point for epoch time of the serving satellite ephemeris and Common TA parameters is the uplink time
synchronization reference point.
epochTime is the starting time of a DL subframe indicated by startSFN and startSubframe. For serving cell,
the startSFN indicates the current SFN or the next upcoming SFN after the frame where the message
indicating the epochTime is received.
If the field is absent, the UE uses the starting time of the DL subframe corresponding to the end of the SI
window during which the SI message carrying SIB31 is transmitted.
E-UTRAN always includes epochTime when SystemInformationBlockType31 is provided through dedicated
signalling.
In case of handover or conditional handover, this field is based on the timing of the target cell, i.e. the
startSFN and startSubFrame number indicated in this field refers to the SFN and sub-frame of the target
cell, and UE considers the target cell epoch time (indicated by the startSFN and startSubFrame in this field)
to be the frame nearest to the frame where RRCConnectionReconfiguration message is received.
k-Mac
Scheduling offset used when downlink and uplink frame timing are not aligned at the eNB, see TS 36.213
[23]. Unit in ms.
If the field if absent, the UE uses the (default) value of 0.
k-Offset
Scheduling offset used in the timing relationships in NTN, see TS 36.213 [23]. Unit in ms.
nta-Common
Network-controlled common TA, see TS 36.213 [23]. Unit of μs.
Step of 32.55208 × 10⁻³ μs. Actual value = field value * 32.55208 × 10⁻³.
If the field is absent, the UE uses the (default) value of 0.
nta-CommonDrift
Drift rate of the common TA, see TS 36.213 [23]. Unit of μs/s.
Step of 0.2 × 10⁻³ μs/s. Actual value = field value * 0.2 × 10⁻³.
If the field is absent, the UE uses the (default) value of 0.
nta-CommonDriftVariation
Drift rate variation of the common TA, see TS 36.213 [23]. Unit of μs/s².
Step of 0.2 × 10⁻⁴ μs/s². Actual value = field value * 0.2 × 10⁻⁴.
If the field is absent, the UE uses the (default) value of 0.
orbitalParameters
Instantaneous values of the satellite orbital parameters. The signalled values are only valid for the duration
as defined by ul-SyncValidityDuration and epochTime.
stateVectors
Instantaneous values of the satellite state vectors. The signalled values are only valid for the duration as
defined by ul-SyncValidityDuration and epochTime.
ul-SyncValidityDuration
Validity duration of the satellite ephemeris data and common TA parameters, i.e. maximum time duration
(from epochTime) during which the UE can apply the satellite ephemeris without acquiring new satellite
ephemeris, see TS 36.213 [23]. Unit in second.
Value s5 corresponds to 5 seconds, value s10 corresponds to 10 seconds and so on.

### 3GPP TS 36.331 V17.4.0

The system information contains the following:
Serving cell ephemeris elements. This allows the UE to calculate the satellite position for doppler and time pre-compensation. This information may be provided in two formats:
PVT format. This describes a (X, Y, Z) position as well as a speed vector (vX, vY, vZ).
Orbital parameters. This describes the orbital movements of the satellite which is then used to infer the satellite position.
TA common parameters. This provides the common timing advance parameters which is introduced to compensate for the feeder link delays. The signalling comprises the following (in total taking up 57 bits):
Absolute TA common (23 bits).
Drift of the TA common, defining how the TA common drifts, i.e. the first derivative of the TA common (19 bits).
Variation of the TA common, defining how the TA common varies, i.e. the second derivative of the TA common (15 bits).
Synchronization validity duration. This is used to define how long the ephemeris and TA common is valid.
Epoch time. This defines when the synchronization validity duration should start.
K-Offset. This is a scheduling offset for timing relationship in NTN.
K-Mac. This is a scheduling offset used when the downlink and uplink frame timing is not aligned.
NR NTN specific information also includes (as part of 3GPP TS 38.331):
T-Service (signalled in SIB3 in IoT NTN).
Reference location and distance threshold. This is used for location-based measurement initiation in RRC IDLE and RRC Connected mode.
Neighbour cell ephemeris. This is used for idle mode measurements.

### Overview of NTN System Information Acquisition

As ephemeris information constantly changes due to the movement of the NTN payload (e.g. satellite), there is a need to make sure that the UE is correctly synchronized. Thus, whenever a UE connects to an eNB, the UE needs to read the system information (e.g. SIB19 or SIB31).

In IoT NTN, every time SIB31 is read, a timer (T317) associated with the ephemeris element is started. At expiry of T317, the UE is no longer considered synchronized and should re-acquire SIB31 in order to stay synchronized.

In IoT NTN, since an IoT UE (LTE-M and NB-IoT UE) is not expected to be able to acquire system information in connected mode, the UE tunes away and is likely unreachable while reading SIB31.

If the IoT NTN UE is unable to read the SIB31 within a timer (T318) with a configured duration, the UE performs Radio Link Failure (RLF) similar to other cases where RLF is performed. This operation can be seen in FIG. 2: in a) of FIG. 2, SIB31 functions as normal, and in b) of FIG. 2, UE fails to read SIB31 during T318 which then expires and triggers RLF;

In NR NTN, the UE shall ensure that it has a recent ephemeris (SIB19 in NR) by reading the SIB in time by UE implementation.

The T317 timer differs from a normal timer in RRC in that it is not started at having received the SIB31. This is because the ephemeris has an epoch time, which is the reference point in time when the ephemeris is defined. Thus the T317 timer is started from the epoch time, which may be before or after receiving SIB31. This means that in a UE implementation, the timer may be started with a different value from what was signalled based on the field ul-Sync ValidityDuration in SIB31.

### Overview of NTN Ephemeris Formats

There are three ways of signalling the ephemeris in NTN:
1. PVT format,
2. Orbital ephemeris elements, and
3. TLE ephemeris elements (only used for Discontinuous Coverage in IoT NTN).

### PVT Format

PVT format signals XYZ position along with the speed vector vXYZ. This can be seen in the following information element:

### 3GPP TS 36.331 V17.4.0

EphemerisState Vectors

The IE EphemerisStateVectors provides satellite ephemeris in format of position and velocity state vectors in ECEF.

EphemerisStateVectors information element

| -- ASN1START | |
|---|---|
| EphemerisStateVectors-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}
PositionStateVector-r17 ::= INTEGER (−33554432..33554431)
VelocityStateVector-r17 ::= INTEGER (−131072..131071)
-- ASN1STOP

EphemerisStateVectors field descriptions

positionX, positionY, positionZ
X, Y, Z coordinate of satellite position state vector in ECEF. Unit in
meter. Step of 1.3 m. Actual value = field value * 1.3.
velocityVX, velocityVY, velocityVZ
X, Y, Z coordinate of satellite velocity state vector in ECEF. Unit in
meter/second. Step of 0.06 m/s. Actual value = field value * 0.06.

### 3GPP TS 36.331 V17.4.0

The position elements (X, Y, Z respectively) each occupy 26 bits and the speed elements (vX, vY, vZ) each occupy 18 bits. Altogether they occupy 132 bits.

### Orbital Ephemeris Format

The ephemeris orbital parameters (also referred to as Keplerian format) provide parameters that indicate how a celestial body moves in space, which allows for accurate synchronization and prediction of future NTN payload position.

Ephemeris orbital elements are signalled by the following elements (164 bits total):
SemiMajorAxis (33 bits)
Eccentricity (20 bits)
Periapsis (28 bits)
Longitude (28 bits)
Inclination (27 bits)
Anomaly (28 bits)

### TLE Orbital Parameters

The TLE parameters are based on Two-Line Element set (TLE), which is industry-acknowledged data format for signalling the movement of a celestial body. Whereas the PVT and orbital ephemeris formats may be used to perform accurate synchronization, TLE parameters may be used primarily for long term prediction. For example, the TLE parameters allow for accurate satellite-pass prediction of up to several days in the future.

A full set of TLE parameters can occupy more than 50 Bytes of data containing many fields not required in 3GPP. Therefore, a reduced set of TLE parameters may be used instead, for example based on the following (totalling 189 bits):
Inclination (21 bits)
Argument of perigee (22 bits)
Right ascension of the ascending node (22 bits)
Mean anomaly (22 bits)
Eccentricity (24 bits)
Mean Motion (34 bits)
B* signalled by (i) a decimal (18 bits), and (ii) an exponent (5 bits)
Epoch star (21 bits)

The above information is presented as background information only to assist with an understanding of the present disclosure. No determination has been made, and no assertion is made, as to whether any of the above might be applicable as prior art with regard to the present invention.

Certain examples of the present disclosure provide one or more techniques for acquiring neighbour cell information in a NTN. For example, certain examples of the present disclosure provide one or more techniques for acquiring neighbour cell information in a 3GPP 5G NR NTN. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a NG-RAN node (e.g. a base station or gNB) in the examples below may be applied to any other suitable type of entity performing RAN functions.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

In 3GPP Release 17, ephemeris information was introduced to be broadcasted, which is important for the UE to be able to synchronize to the serving cell. Due to this, the notion of sync validity was introduced where the ephemeris is deemed valid for a specific time duration defined by timer T317, and the UE is required to re-acquire the ephemeris in regular intervals during a period defined by timer T318.

In Release 18, neighbour cell assistance information containing ephemeris information will be introduced for the purpose of neighbour cell measurements. Similar to synchronizing with the serving cell, the neighbour cell assistance information also need to be kept up-to-date as measurement quality will deteriorate if the UE is not properly synchronized with the cell that it is measuring.

In current 3GPP discussions, it is being discussed how to acquire the neighbour cell assistance information, and it was agreed that a new SIB is to be introduced to broadcast this information. It was also discussed how the UE acquires the new SIB and it was proposed that a UE can acquire the new SIB during the timer T318. In 3GPP R2-2306664, the following is proposed:

Proposal 2 Agree one of the options below
(9/13) No validity duration introduced for SIBxx. It is up to UE implementation when to acquire SIBxx, for example, UE may assume validity duration of SIBxx is same as serving satellite or may rely on T318 in connected mode (i.e., of SIB31).
(2/13) explicit validity duration introduced for SIBxx. Absence of validation duration means service satellite validation duration applies. In connected mode, UE relies on T318 to acquire SIBxx. FFS which neighbor cell epoch time to use to start validity duration.
(2/13) Mandatory explicit validity duration introduced for SIBxx. In connected mode, UE relies on T318 to acquire SIBxx. FFS which neighbor cell epoch time to use to start validity duration.

There are however some open issues with regards to how to acquire the new SIB:
One example is for instance with T318, which is started when T317 has expired. During T318 the UE shall attempt to acquire SIB31. However, the timer T318 is stopped if the UE succeeds in acquiring SIB31, meaning that there might not be any time to acquire the new SIB.
Another example is if a new validity duration for new SIB is introduced, how the start of this timer is defined.

Certain examples of the present disclosure provide one or more techniques for signalling neighbouring cell information (e.g. neighbour cell assistance information).

The skilled person will appreciate that ephemeris is not only applicable to satellite payloads, but can also apply to other platforms, such a HAPS (High Altitude Platform Systems). Accordingly, techniques described herein referring to “satellite ephemeris” may be applied not only to satellites but also to any other suitable NTN platforms and/or payloads.

In the accompanying figures, it is illustrated that the T317 is started at the point of receiving SIB31. However, this may be interpreted as starting the T317 at epoch time, which may be slightly before or after having received the SIB31.

The main purpose of the newly introduced SIB is to carry NTN neighbour cell assistance. This neighbour cell assistance may contain various items of information, for example one or more of the ephemeris of the cell, the satellite ID, the Timing Advance common parameters, the k-Offset and the k-Mac. In the present disclosure, references to “acquiring new SIB”, “acquiring neighbour cell ephemeris”, “acquiring neighbour cell assistance information” and the like may be regarded as equivalent, involving performing the same or similar UE action, for example monitoring for, detecting and decoding the information in the new SIB.

The skilled person will appreciate that the various techniques disclosed herein may be applied to examples including gNB and/or NG-RAN, examples including various related, newly defined and/or existing signalling and/or messages (e.g. RRC, X2, Xn, S1, NG and/or F1 signalling and/or messages), and/or examples including various related network entities (e.g. MME, AMF, other).

The skilled person will also appreciate that the various techniques disclosed herein may be applied to NR NTN.

Certain examples of the present disclosure provide a method, for a User Equipment (UE), for acquiring first cell information (e.g. first ephemeris information) of a first cell (e.g. a serving cell) and second cell information (e.g. second ephemeris) of a second cell (e.g. a neighbouring cell), wherein the second cell is a Non Terrestrial Network (NTN), the method comprising: in response to expiry of a first timer (e.g. T317), indicating that validity of previously acquired first cell information has expired, starting a second timer (e.g. T318 or a newly defined timer); attempting to acquire the first cell information and the second cell information during the second timer period; and upon expiry of the second timer, performing a Radio Link Failure (RLF) procedure if the first cell information has not been successfully acquired, whether or not the second cell information has been successfully acquired.

Certain examples of the present disclosure provide a method, for a User Equipment (UE), for acquiring first cell information (e.g. first ephemeris information) of a first cell (e.g. a serving cell) and second cell information (e.g. second ephemeris) of a second cell (e.g. a neighbouring cell), wherein the second cell is a Non Terrestrial Network (NTN), the method comprising: in response to expiry of a first timer (e.g. T317), indicating that validity of previously acquired first cell information has expired, starting a second timer (e.g. T318 or a newly defined timer); attempting to acquire the first cell information and the second cell information during the second timer period; and upon expiry of the second timer, not performing a RLF procedure if the first cell information has been successfully acquired.

In certain examples, the second timer may not be stopped when the first cell information is successfully acquired.

In certain examples, the method may further comprise stopping the second timer when both the first cell information and the second cell information have been successfully acquired.

In certain examples, the method may further comprise: determining whether the UE is capable of acquiring the second cell information.

In certain examples, the UE may attempt to acquire the second cell information if it is determined that the UE is capable of acquiring the second cell information.

In certain examples, if it is determined that the UE is not capable of acquiring the second cell information, the method may further comprise stopping the second timer when the first cell information has been successfully acquired.

In certain examples, the UE may attempt to acquire the second cell information during the second timer period only if validity of previously acquired second cell information has expired.

In certain examples, the method may further comprise: if the validity of previously acquired second cell information has expired, attempting to acquire the second cell information during the next occasion of the second timer period.

In certain examples: the second timer period may run at least partly after the first timer period; the second timer period may run at least partly before the first timer period; and/or the second timer period may run at least partly concurrently with the first timer period.

In certain examples, the first cell may be an NTN cell or a Terrestrial Network (TN) cell.

Certain examples of the present disclosure (e.g. a first example) provide a method, for a User Equipment (UE), for acquiring first cell information (e.g. first ephemeris information) of a first cell (e.g. a serving cell) and second cell information (e.g. second ephemeris) of a second cell (e.g. a neighbouring cell), wherein the second cell is a Non Terrestrial Network (NTN), the method comprising: in response to expiry of a first timer (e.g. T317), indicating that validity of previously acquired first cell information has expired, starting a second timer (e.g. T318 or a newly defined timer); attempting to acquire the first cell information and the second cell information during the second timer period; and upon expiry of the second timer, performing a Radio Link Failure (RLF) procedure based on whether the first and/or second cell information has been successfully acquired.

In certain examples (e.g. a second example according to the first example), the second timer may not be stopped when the first cell information is successfully acquired.

In certain examples (e.g. a third example according to the first or second examples), the RLF procedure may be performed if the first cell information has not been successfully acquired on expiry of the second timer, whether or not the second cell information has been successfully acquired.

In certain examples (e.g. a fourth example according to the first or second examples), the RLF procedure may be performed if neither the first cell information nor the second cell information has been successfully acquired on expiry of the second timer.

In certain examples (e.g. a fifth example according to any of the first to fourth examples), the method may further comprise: if the second cell information is not successfully acquired, transmitting (e.g. in an RRC message), to a base station (e.g. a base station of the first cell), an indication (e.g. noNeighbourCellAssistance flag) that the second cell information has not been successfully acquired.

In certain examples (e.g. a sixth example according to any of the first to fifth examples), according to a network configuration, the RLF procedure may be performed based on whether the second cell information has been successfully acquired.

In certain examples (e.g. a seventh example according to any of the first to sixth examples), the method may further comprise: determining whether the UE is capable of acquiring the second cell information.

In certain examples (e.g. an eighth example according to the seventh example), the UE may attempt to acquire the second cell information if it is determined that the UE is capable of acquiring the second cell information.

In certain examples (e.g. a ninth example according to the seventh or eighth examples), the second timer may be selected (e.g. from T318 or a newly defined timer) based on whether the UE is capable of acquiring the second cell information.

In certain examples (e.g. a tenth example according to any of the first to ninth examples), the UE may attempt to acquire the second cell information during the second timer period only if validity of previously acquired second cell information has expired.

In certain examples (e.g. an eleventh example according to the tenth example), a validity period for the second cell information may be longer than (e.g. a multiple of) a validity period for the first cell information.

In certain examples (e.g. a twelfth example according to any of the first to eleventh examples), the method may further comprise: if the UE fails to acquire the second cell information during the second timer period, attempting to acquire the second cell information during the next occasion of the second timer period.

Certain examples of the present disclosure (e.g. a thirteenth example) provide a method, for a User Equipment (UE), for acquiring first cell information (e.g. first ephemeris information) of a first cell (e.g. a serving cell) and second cell information (e.g. second ephemeris) of a second cell (e.g. a neighbouring cell), wherein the second cell is a Non Terrestrial Network (NTN), the method comprising: in response to expiry of a first timer (e.g. T317), indicating that validity of previously acquired first cell information has expired, starting a second timer (e.g. T318); attempting to acquire the first cell information during the second timer period; if the first cell information is successfully acquired during the second timer period, stopping the second timer; in response to stopping the second timer, starting a third timer (e.g. a newly defined timer); and attempting to acquire the second cell information during the third timer period.

In certain examples (e.g. a fourteenth example according to the thirteenth example), the method may further comprise: performing a Radio Link Failure (RLF) procedure if the first cell information is not successfully acquired during the second timer period.

In certain examples (e.g. a fifteenth example according to the thirteenth or fourteenth examples), the method may further comprise: performing an RLF procedure if the second cell information is not successfully acquired during the third timer period.

In certain examples (e.g. a sixteenth example according to any of the first to fifteenth examples), the second timer and/or the third timer may be broadcast and/or dedicatedly configured (e.g. via RRC).

In certain examples (e.g. a seventeenth example according to any of the thirteenth to sixteenth examples), the third timer may be started and the UE may attempt to acquire the second cell information during the third timer period only if validity of previously acquired second cell information has expired.

In certain examples (e.g. an eighteenth example according to the seventeenth example), a validity period for the second cell information may be longer than (e.g. a multiple of) a validity period for the first cell information.

Certain examples of the present disclosure (e.g. a nineteenth example) provide a method, for a User Equipment (UE), for acquiring first cell information (e.g. first ephemeris information) of a first cell (e.g. a serving cell) and second cell information (e.g. second ephemeris) of a second cell (e.g. a neighbouring cell), wherein the second cell is a Non Terrestrial Network (NTN), the method comprising: attempting to acquire the first cell information during a second timer period defined by a second timer; and attempting to acquire the second cell information during a third timer period defined by a third timer, wherein the second timer period and the third timer period occur after expiry of a first timer period defined by a first timer (e.g. T317), indicating that validity of previously acquired first cell information has expired.

In certain examples (e.g. a twentieth example according to the nineteenth example), the second timer and the third timer may be the same timer (one single timer).

In certain examples (e.g. a twenty first example according to the twentieth example), the one single timer may be timer T318 or a newly defined timer.

In certain examples (e.g. a twenty second example according to the nineteenth example), the second timer may be different from the third timer.

In certain examples (e.g. a twenty third example according to the twenty second example), the second timer may be timer T318 and the third timer may be a newly defined timer.

In certain examples (e.g. a twenty fourth example according to any of the first to twenty third examples): the second timer period may run at least partly after the first timer period; the second timer period may run at least partly before the first timer period; and/or the second timer period may run at least partly concurrently with the first timer period.

In certain examples (e.g. a twenty fifth example according to any of the first to twenty fourth examples), the method may further comprise performing a Radio Link Failure (RLF) procedure based on whether the first and/or second cell information has been successfully acquired.

In certain examples (e.g. a twenty sixth example according to any of the first to twenty fifth examples), the first cell may be an NTN cell or a Terrestrial Network (TN) cell.

Certain examples of the present disclosure provide a User Equipment (UE) configured to perform a method according to any example, aspect, embodiment and/or claim disclosed herein.

Certain examples of the present disclosure provide a network (or wireless communication system) comprising a base station and a UE according to any example, aspect, embodiment and/or claim disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

Various further detailed examples will now be described.

### 1. Acquiring New SIB During T318

According to existing features, when attempting to acquire a new SIB along with SIB31 during T318, there is a problem that T318 has been defined to be stopped as soon as SIB31 has been acquired. This means that unless the new SIB is acquired before the SIB31, then with current conditions acquiring the SIB31 may not allow for acquiring the new SIB. Thus, in certain examples, the T318 will continue running after acquiring the SIB31 to acquire the new SIB. This scenario is disclosed in FIG. 3 and in specification Example 1 further below. In certain examples, the condition to continue running the timer may be based on one or more of the following:
If the UE is capable of performing neighbour cell measurements using ephemeris from the new SIB
If the new SIB is broadcasted
If configured by the network, such as a dedicated flag in broadcasted SIB (such as SIB31), or dedicatedly configured

In certain examples, when the T318 expires, the UE may perform Radio Link Failure (RLF). However, as the new SIB may not be as important in order for the UE to stay synchronized, it may be less useful for the UE to perform RLF based on not acquiring the new SIB. Accordingly, in certain examples the UE will not perform RLF if the T318 has expired and the new SIB has not been acquired. In certain examples, the UE will not perform RLF if the T318 has expired and SIB31 has been acquired. Without this, the UE may unnecessarily perform RLF due to not having acquired the new SIB. Examples of this technique are disclosed in specification Example 1 further below. In certain examples, the UE will not perform RLF if the SIB31 is received during T318, regardless of whether the new SIB is received or not before the expiry of T318.

In the techniques described above, if the UE acquires the new SIB in T318, before acquiring the SIB31, the UE will wait for the expiry of the T318 before triggering RLF if the UE does not acquire SIB31.

In certain examples, the UE shall not trigger RLF if failing to acquire the new SIB. In these examples, it can be indicated to the eNB if the new SIB has not been acquired. For example this may be reported using a flag noNeighbourCellAssistance in an RRC message, such as a measurement report. Thus when a measurement report is triggered, the UE will include this flag which indicates that the UE has not acquired the new SIB. In certain examples, missing the neighbour cell assistance information may trigger a measurement report itself. In this case the UE may include all the measurements performed before the failure to perform the measurement.

In certain examples, it may be network-configurable whether a UE shall acquire the new SIB in T318, or in RRC connected mode. This can for instance be useful if it is deemed that the neighbour cell ephemeris does not change a lot and the UE shall only acquire the new SIB once. As another example, it may be made configurable whether to perform RLF when the UE is unable to acquire the new SIB when the UE is configured with conditional handover. Both of these options may be, for example, dedicatedly configured. This can be useful as the overall configuration may be broadcasted, and then the configured exceptions as above may be dedicated. There may also be a capability report indicating that the UE is capable of acquiring the new SIB during T318.

### 2. Acquiring New SIB During New Timer (T3xx/T319)

In certain examples, a new timer is introduced to acquire both SIB31 and new SIB. The new timer may be referred to as T3XX, or any other suitable name, such as T319, T318a or T328. The skilled person will appreciate that T3XX is a generic name for new unnamed timers, so it should not be confused with other cases in which “T3XX” is used as a generic name for another new unnamed timer.

In certain examples, the new timer may be configurable and only used for a UE that is capable of acquiring the new SIB. The new timer may be started after T317. Upon expiry of the new timer there may be various scenarios. For example, the UE may apply one or more of: (i) only perform RLF if SIB31 has not been acquired, (ii) perform RLF if SIB31 or the new SIB has not been acquired, and (iii) perform RLF if neither SIB31 nor the new SIB has been acquired. In certain examples, it may be stopped upon having acquired both SIB31 and new SIB. This may be applied for all of the three preceding RLF conditions. An example of a new timer is illustrated in FIG. 4. The UE may be configured to use this timer if T318 is also configured or broadcasted. This means that if a UE is capable of performing neighbour cell measurements using neighbour cell assistance, and the UE is broadcasting the new SIB, the UE shall use the new timer even if T318 is broadcasted.

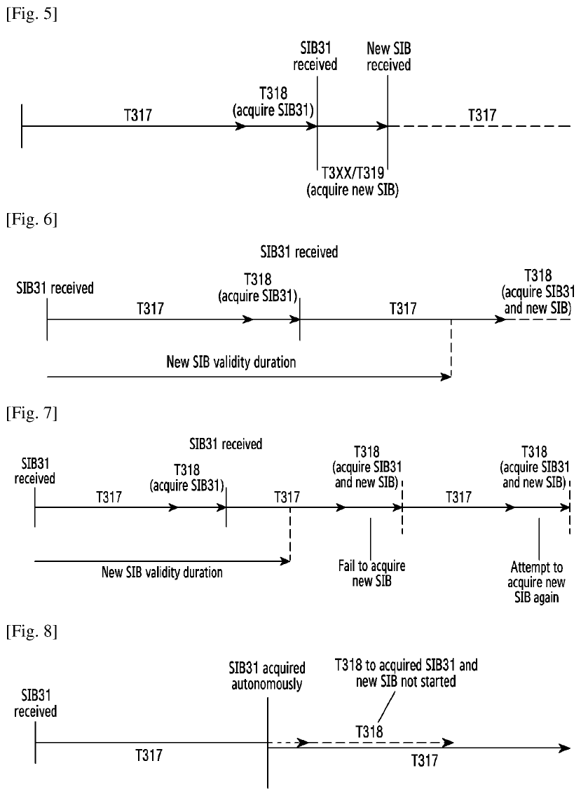

In certain examples, upon stopping the T318 timer, the UE may start another timer specifically for acquiring the new SIB. This timer is only used for the new SIB. Examples of this technique are illustrated in FIG. 5 and given in specification Example 2 further below. When the T317 starts, it will start according to the epoch time as indicated in SIB31.

In certain examples, this new timer can either be broadcasted or dedicatedly configured via RRC (e.g. existing and/or newly defined signalling/messages). The timer may be both broadcasted and dedicated, or it may be only dedicatedly configured. An example of the new timer defined as T319 is given in specification Example 4 further below. In certain examples, there may be a separate capability for the new timer.

### 3. New Validity Duration for New SIB

in certain examples, there may be a new (and separate) validity duration introduced for the new SIB. This may have the benefit that the validity duration for the new SIB may be longer compared to the validity duration of the serving cell (i.e. T317 and uplinkSync ValidityDuration). This may be practical in certain examples as there may be less stringent requirements on tight synchronized when performing neighbour cell measurements compared to adjusting timing advance for uplink and downlink transmissions.

In certain examples, a validity duration may be defined for the new SIB. In certain examples, this validity duration may (only) indicate to the UE in which T318 opportunity the UE shall acquire the new SIB. What this means is that, upon expiry of the validity duration, the UE waits until the next T318 duration to acquire the new SIB. The validity duration thus configures the UE to acquire the new SIB at the next T318 opportunity. An example of this technique is illustrated in FIG. 6. According to this technique, acquisition of the new SIB is not attempted or not needed in every T318 occasion. When the new SIB is acquired in a T318 occasion, then any of the above techniques, relating to how T318 should operate when reading new SIB, may be applied, for example (i) extending T318, and/or (ii) not performing RLF if the T318 expires.

In certain examples, the validity duration for the new SIB may be defined as a multiple of the validity duration in SIB31. In other examples, the validity duration for the new SIB may be defined as a fraction of the validity duration in SIB31. The skilled person will appreciate that the validity duration for the new SIB may be defined according to any suitable other technique.

In certain examples, if the UE fails to acquire the new SIB in a given (or current) T318 occasion, then the UE will attempt to re-acquire the new SIB in the next T318 occasion (and thus not trigger RLF). An example of this technique is illustrated in FIG. 7. Once the new SIB has been acquired, the validity duration starts.

One issue with a validity duration is that it needs to be started at some point. In Release 17, for serving cell uplink sync validity duration, the start of the validity duration is defined by a parameter called epochTime, which is also where the ephemeris value is defined to be started. If a new validity duration is introduced for the new SIB, the start of the validity duration should be defined.

In certain examples, the start of the validity duration of the new SIB is the same as that for the serving cell, i.e. the validity duration for SIB31. This can also be defined as the epoch time being the same as that for the serving cell, i.e. epochTime in SIB31. For example, this can be done if the UE acquires the new SIB at roughly the same time as the SIB31.

In certain examples, the start of the validity duration of the new SIB is different to that of the serving cell, i.e. validity duration for SIB31, but not indicated explicitly. For example, the start of the validity duration of the new SIB may be shifted by a given time period compared to the serving cell (i.e. in SIB31). In some examples, this may be a predetermined time period.

In certain examples, there may be a capability bit associated with a UE being able to have a validity duration specifically for the new SIB.

### 4. Other Embodiments

In certain examples, the UE may be required to acquire the new SIB when it is configured with conditional handover. This is important as performing the handover may be more important when the UE has been configured with a conditional handover.

As the starting and expiry conditions have been described above, a timer may also have a stopping condition. In certain examples, for the timers above, the UE may be configured to stop the timer for acquiring the new SIB (and SIB31) when both the new SIB and SIB31 has been acquired. In the case where only the new SIB is acquired, then the timer may be stopped when acquiring the new SIB. Upon stopping the timer, the UE may continue to receive data and transmit data with an eNB. Furthermore, the T317 timer may be started upon stopping the timer. In certain examples, when T318 is stopped, the T317 can be re-started. In other examples, T317 may be started upon acquiring SIB31. In this case, T318 and T317 might overlap slightly (i.e. this may happen when SIB31 has been acquired, but new SIB has yet to be acquired).

In certain examples, the UE is configured to not perform neighbour cell measurements if the new SIB (i.e. the neighbour cell assistance information) is not valid. This is because it might not be useful for the network to receive neighbour cell measurements if the measurements have been performed when UE is unsynchronized with respect to the neighbouring cells. It could also allow for energy savings at the UE by not performing neighbour cell measurements in this case.

In certain examples, when the new neighbour cell assistance information in the new SIB has been acquired, it can be indicated to the lower layers to perform measurements, if needed.

In certain examples, it can be configured that a UE does not report measurements made on neighbouring cells if the neighbour cell assistance information is not valid.

In certain examples, the UE is supplied with the neighbour cell assistance information new SIB when the UE is configured with Conditional handover.

In Release 17 IoT NTN, when the T318 has stopped due to SIB31 having been acquired, it will be indicated to the lower layers that uplink sync has been restored. However, in certain examples described herein, the T318 may continue running despite SIB31 having been acquired. To address this, in certain examples the uplink sync can be restored despite T318 continuing to run. In other examples, if a new timer is introduced (e.g. T319), the uplink sync will be restored despite the timer running when SIB31 has been acquired. Examples of these techniques are given in specification Examples 1 and 4 further below.

In certain examples, if the new SIB is considered very important and if a UE should not operate without having acquired it, the UE can be configured to trigger RLF if the new SIB has not been acquired. This can be important for the network to be able to configure in certain scenarios where neighbour cell measurements are considered crucial for stable network performance, such as cases where mobility occurs often. A new RLF cause value may be introduced to signal to the network the reason for the RLF. This may be defined as “unable to acquire new SIB”, “unable to acquire neighbour cell ephemeris”, “unable to acquire SIB during T318”, etc.

In certain examples, a Radio Link Failure report may be triggered to be sent (from UE to network) if the network triggers this. The Radio Link Failure report may contain any suitable information regarding the failure, for example one or more of measurements during the failure, time of failure, location information related to the failure, cause of the failure, etc.

An example of a new RLF-cause is given in specification Example 3 further below. This is a general example where it can be triggered either due to unable to acquire SIB31 or new SIB.

In certain examples, a new RLF-cause is introduced if the T318 expires.

In certain examples, if new timer T319 is introduced, then RLF may be triggered upon expiry, and a new RLF cause may be added.

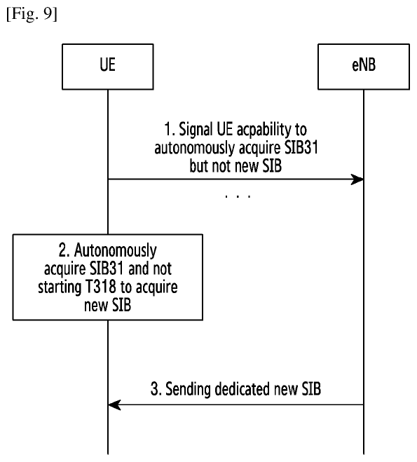

In certain examples, if the UE is capable of acquiring SIB31 in connected mode and continuously performing downlink and uplink procedure, then the timer T317 will continue to be updated and the timer T318 will never start. An example of this is illustrated in FIG. 8. This may be a problem if the new SIB is sufficiently large where acquiring the new SIB requires tuning away to not be able to perform downlink and uplink procedures. In this case, there might not be any opportunity for the UE to acquire the new SIB. Thus, in certain examples, the capability of acquiring SIB31 autonomously may be signalled. This may be interpreted as the capability to acquire SIB31 autonomously, but not acquiring the new SIB autonomously. Knowing this, the network may for instance signal the new SIB dedicatedly. An example of these procedures is illustrated in FIG. 9.

In various examples of the present disclosure, reference may be made to acquiring second cell information (where “second cell” may refer to “neighbour cell”, for example), new SIB, assistance information, and similar. This information/SIB may comprise ephemeris, for example. The skilled person will appreciate that the information/SIB may relate to one cell or a set of one or more cells. For example, a set of ephemeris elements for a set of cells (e.g. multiple neighbour cells) may be acquired by a UE.

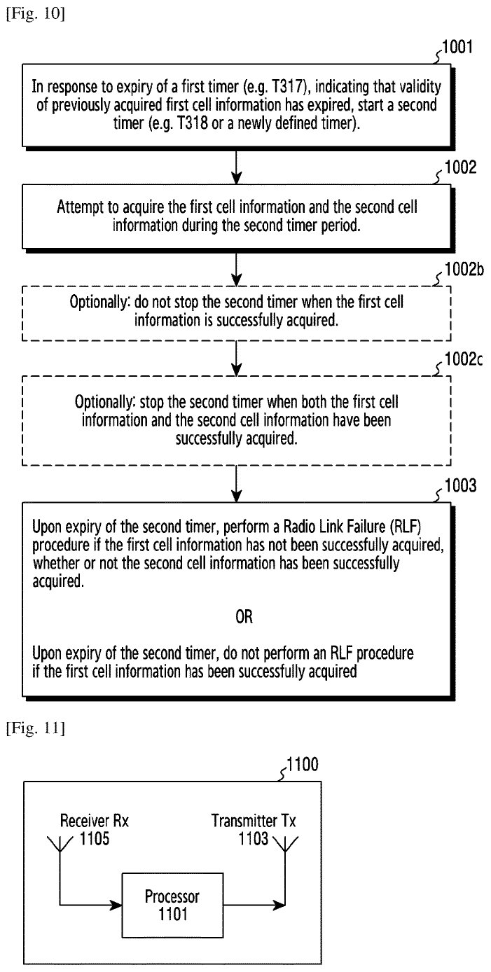

FIG. 10 is a flow diagram of an exemplary method, for a UE, for acquiring first cell information (e.g. first ephemeris information) of a first cell (e.g. a serving cell) and second cell information (e.g. second ephemeris) of one or more second cells (e.g. one or more neighbouring cells), wherein the second cells are Non Terrestrial Network (NTN) cells.

In a first step 1001, in response to expiry of a first timer (e.g. T317), indicating that validity of previously acquired first cell information has expired, a second timer (e.g. T318 or a newly defined timer) is started.

In a second step 1002, the UE attempts to acquire the first cell information and the second cell information during the second timer period.

In a third step 1003, upon expiry of the second timer, a Radio Link Failure (RLF) procedure is performed if the first cell information has not been successfully acquired, whether or not the second cell information has been successfully acquired. Alternatively, in the third step 1003, upon expiry of the second timer, an RLF procedure is not performed if the first cell information has been successfully acquired.

In certain examples, one or more conditions or criteria may be applied to determine whether or not to stop the second timer. For example: optionally in step 1002b, the second timer is not stopped when the first cell information is successfully acquired; and/or optionally in step 1002c, the second timer is stopped when both the first cell information and the second cell information have been successfully acquired.

In certain examples, it is determined whether the UE is capable of acquiring the second cell information. In this case, in the second step 1002 above, the UE attempts to acquire the second cell information (only) if it is determined that the UE is capable of acquiring the second cell information. If it is determined that the UE is not capable of acquiring the second cell information, as an alternative to step 1002c above, the second timer is stopped when the first cell information has been successfully acquired.

Various specification examples will now be described.

### EXAMPLES

### Example 1

In this example, the T318 timer does not stop when SIB31 has been acquired and a radio link failure will not be triggered if SIB31 has been acquired.

### Example Based on 3GPP TS 36.331 V17.4.0

### 5.3.18 T317 Expiry

The UE shall:
1> if in RRC_CONNECTED:
2> inform lower layers that the UL synchronisation is lost;
2> start timer T318;
2> acquire SystemInformationBlockType31 (SystemInformationBlockType31-NB in NB-IoT) as specified in 5.2.2;
2> if UE is capable of performing NTN neighbour cell measurements using assistance information:
3> acquire SystemInformationBlockTypeXX (SystemInformationBlockTypeXX-NB in NB-IoT)
2> if a UE is capable of NTN neighbour cell measurements using assistance information:
3> upon successful acquisition of SystemInformationBlockType31 (SystemInformationBlockType31-NB in NB-IoT):
4> inform lower layers when UL synchronisation is restored.
3> upon successful acquisition of SystemInformationBlockType31
(SystemInformationBlockType31-NB in NB-IoT) and SystemInformationBlockTypeXX (SystemInformationBlockTypeXX-NB in NB-IoT):
4> stop timer T318;
2> else (for other UEs):
3> upon successful acquisition of SystemInformationBlockType31 (SystemInformationBlockType31-NB in NB-IoT):
4> stop timer T318;
4> inform lower layers when UL synchronisation is restored.

NOTE 1: SystemInformationBlockType31 (SystemInformationBlockType31-NB in NB-IoT) may be broadcast on a different narrowband or different NB-IoT carrier than the one configured to the UE.

NOTE 2: The exact time when UL synchronisation is restored (after SystemInformationBlockType31 or SystemInformationBlockType31-NB in NB-IoT is acquired) is left to UE implementation, which can be from the subframe indicated by epochTime and optionally before the subframe indicated by epochTime.

### Example Based on 3GPP TS 36.331 V17.4.0

### 5.3.11.3 Detection of Radio Link Failure

The UE shall:
1> in case any DAPS bearer is configured, only the target PCell is considered in the following;
1> upon T310 expiry; or
1> upon T312 expiry; or
1> upon T318 expiry and if SystemInformationBlockType31(-NB) has not been acquired; or
1> upon random access problem indication from MCG MAC while neither T300, T301, T304 nor T311 is running; or
1> upon indication from MCG RLC, which is allowed to be send on PCell, that the maximum number of retransmissions has been reached for an SRB or DRB:
2> consider radio link failure to be detected for the MCG i.e. RLF;
2> discard any segments of segmented RRC messages received;
2> store the following radio link failure information in the VarRLF-Report (VarRLF-Report-NB in NB-IoT) by setting its fields as follows:
3> clear the information included in VarRLF-Report (VarRLF-Report-NB in NB-IoT), if any;
3> set the plmn-IdentityList to include the list of EPLMNs stored by the UE (i.e. includes the RPLMN);
3> set the measResultLastServCell to include the RSRP and RSRQ, if available, of the PCell based on measurements collected up to the moment the UE detected radio link failure;
3> except for NB-IoT, set the measResultNeighCells to include the best measured cells, other than the PCell, ordered such that the best cell is listed first, and based on measurements collected up to the moment the UE detected radio link failure, and set its fields as follows;
4> if the UE was configured to perform measurements for one or more EUTRA frequencies, include the measResultListEUTRA;
4> if the UE was configured to perform measurement reporting for one or more neighbouring UTRA frequencies, include the measResultListUTRA;
4> if the UE was configured to perform measurement reporting for one or more neighbouring GERAN frequencies, include the measResultListGERAN;
4> if the UE was configured to perform measurement reporting for one or more neighbouring CDMA2000 frequencies, include the measResultsCDMA2000;
4> if the UE was configured to perform measurement reporting, not related to NR sidelink communication, for one or more neighbouring NR frequencies, include the measResultListNR;
4> for each neighbour cell included, include the optional fields that are available;

NOTE 1: The measured quantities are filtered by the L3 filter as configured in the mobility measurement configuration. The measurements are based on the time domain measurement resource restriction, if configured. Exclude-listed cells are not required to be reported.
3> except for NB-IoT, if available, set the logMeasResultListWLAN to include the WLAN measurement results, in order of decreasing RSSI for WLAN APs;
3> except for NB-IoT, if available, set the logMeasResultListBT to include the Bluetooth measurement results, in order of decreasing RSSI for Bluetooth beacons;
3> if detailed location information is available, set the content of the locationInfo as follows:
4> include the locationCoordinates;
4> include the horizontalVelocity, if available;
3> set the failedPCellId to the global cell identity, if available, and otherwise, except for NB-IoT, to the physical cell identity and carrier frequency of the PCell where radio link failure is detected;
3> except for NB-IoT, set the tac-FailedPCell to the tracking area code, if available, of the PCell where radio link failure is detected;
3> except for NB-IoT, if an RRCConnectionReconfiguration message including the mobilityControlInfo was received before the connection failure:
4> if the last RRCConnectionReconfiguration message including the mobilityControlInfo concerned an intra E-UTRA handover:
5> include the previousPCellId and set it to the global cell identity of the PCell where the last RRCConnectionReconfiguration message including mobilityControlInfo was received;
5> set the timeConnFailure to the elapsed time since reception of the last RRCConnectionReconfiguration message including the mobilityControlInfo;
4> if the last RRCConnectionReconfiguration message including the mobilityControlInfo concerned a handover to E-UTRA from UTRA and if the UE supports Radio Link Failure Report for Inter-RAT MRO:
5> include the previousUTRA-CellId and set it to the physical cell identity, the carrier frequency and the global cell identity, if available, of the UTRA Cell in which the last RRCConnectionReconfiguration message including mobilityControlInfo was received;
5> set the timeConnFailure to the elapsed time since reception of the last

RRCConnectionReconfiguration message including the mobilityControlInfo;
4> if the last RRCConnectionReconfiguration message including the mobilityControlInfo concerned a handover to E-UTRA from NR and if the UE supports Radio Link Failure Report for Inter-RAT MRO NR:
5> include the previousNR-PCellId and set it to the global cell identity of the PCell where the last RRCConnectionReconfiguration message including mobilityControlInfo was received embedded in NR RRC message MobilityFromNRCommand message as specified in TS 38.331 clause 5.4.3.3;
5> set the timeConnFailure to the elapsed time since reception of the last RRCConnectionReconfiguration message including the mobilityControlInfo embedded in NR RRC message MobilityFromNRCommand message as specified in TS 38.331 clause 5.4.3.3.
3> except for NB-IoT, if the UE supports QCII indication in Radio Link Failure Report and has a DRB for which QCI is 1:
4> include the drb-EstablishedWithQCI−1;
3> except for NB-IoT, set the connectionFailureType to rlf;
3> except for NB-IoT, set the c-RNTI to the C-RNTI used in the PCell;
3> except for NB-IoT, set the rlf-Cause to the trigger for detecting radio link failure;
2> if the UE is configured with (NG) EN-DC; and
2> if T316 is configured; and
2> if SCG transmission is not suspended; and
2> if the SCG is not deactivated; and
2> if neither NR PSCell change nor NR PSCell addition is ongoing (i.e. T304 for the NR PSCell is not running as specified in TS 38.331 [82], clause 5.3.5.5.2, in (NG) EN-DC):
3> initiate the MCG failure information procedure as specified in 5.6.26 to report MCG radio link failure;
2> else:
3> if AS security has not been activated:
4> if the UE is a NB-IoT UE:
5> if the UE is connected to EPC and the UE supports RRC connection re-establishment for the Control Plane CIoT EPS optimisation; or
5> if the UE is connected to 5GC, the UE supports RRC connection re-establishment for the Control Plane CIoT 5GS optimisation and the UE is configured with a truncated 5G-S-TMSI:
6> initiate the RRC connection re-establishment procedure as specified in 5.3.7; 5> else:
6> perform the actions upon leaving RRC_CONNECTED as specified in 5.3.12, with release cause ‘RRC connection failure’;
4> else:
5> perform the actions upon leaving RRC_CONNECTED as specified in 5.3.12, with release cause ‘other’;
3> else:
4> initiate the connection re-establishment procedure as specified in 5.3.7;

### Example Based on 3GPP TS 36.331 V17.4.0

### Example 2

In this example, a new timer is started after T318 is stopped.

### Example Based on 3GPP TS 36.331 V17.4.0

### 5.3.18 T317 Expiry

The UE shall:
1> if in RRC_CONNECTED:
2> inform lower layers that the UL synchronisation is lost;
2> start timer T318;
2> acquire SystemInformationBlockType31 (SystemInformationBlockType31-NB in NB-IoT) as specified in 5.2.2;
2> upon successful acquisition of SystemInformationBlockType31 (SystemInformationBlockType31-NB in NB-IoT):
3> stop timer T318;
3> inform lower layers when UL synchronisation is restored.
3> for a UE capable of NTN neighbour cell measurements:
4> start timer T319;
4> acquire SystemInformationBlockTypeXX (SystemInformationBlockTypeXX-NB in NB-IoT) as specified in 5.2.2;
4> upon successful acquisition of SystemInformationBlockTypeXX (SystemInformationBlockTypeXX-NB in NB-IoT):
4> stop timer T319

NOTE 1: SystemInformationBlockType31 (SystemInformationBlockType31-NB in NB-IoT) may be broadcast on a different narrowband or different NB-IoT carrier than the one configured to the UE.

NOTE 2: The exact time when UL synchronisation is restored (after SystemInformationBlockType31 or SystemInformationBlockType31-NB in NB-IoT is acquired) is left to UE implementation, which can be from the subframe indicated by epochTime and optionally before the subframe indicated by epochTime.

### Example Based on 3GPP TS 36.331 V17.4.0

### Example 3

This example comprises adding an RLF cause due to T318 expiry and unable to acquire SIB31 or new SIB.

### Example Based on 3GPP TS 36.331 V17.4.0

UEInformationResponse message

-- ASN1START

| | |
|---|---|
| UEInformationResponse-r9 ::= | SEQUENCE { |
| rrc-TransactionIdentifier | RRC-TransactionIdentifier, |
| criticalExtensions | CHOICE { |
| c1 | CHOICE { |
| ueInformationResponse-r9 | UEInformationResponse-r9-IEs, |

```
      spare3 NULL, spare2 NULL, spare1 NULL
    },
```

| | |
|---|---|
| criticalExtensionsFuture | SEQUENCE { } |

}
}

| UEInformationResponse-r9-IEs ::= | SEQUENCE { | |
|---|---|---|
| rach-Report-r9 | RACH-Report-r16 | OPTIONAL, |
| rlf-Report-r9 | RLF-Report-r9 | OPTIONAL, |

| | |
|---|---|
| nonCriticalExtension | UEInformationResponse-v930-IEs |

OPTIONAL
}
-- Late non critical extensions
UEInformationResponse-v9e0-IEs ::= SEQUENCE {

| | | |
|---|---|---|
| rlf-Report-v9e0 | RLF-Report-v9e0 | OPTIONAL, |
| nonCriticalExtension | SEQUENCE { } | OPTIONAL |

}

| | . . . | |
|---|---|---|
| RLF-Report-r9 ::= | SEQUENCE { | |
| measResultLastServCell-r9 | SEQUENCE { | |
| rsrpResult-r9 | RSRP-Range, | |
| rsrqResult-r9 | RSRQ-Range | OPTIONAL |

},

| measResultNeighCells-r9 | SEQUENCE { | |
|---|---|---|
| measResultListEUTRA-r9 | MeasResultList2EUTRA-r9 | OPTIONAL, |
| measResultListUTRA-r9 | MeasResultList2UTRA-r9 | OPTIONAL, |
| measResultListGERAN-r9 | MeasResultListGERAN | OPTIONAL, |
| measResultsCDMA2000-r9 | MeasResultList2CDMA2000-r9 | OPTIONAL |

```
  }
    OPTIONAL,
  ...,
```

| | | |
|---|---|---|
| [[ locationInfo-r10 | LocationInfo-r10 | OPTIONAL, |

| | |
|---|---|
| failedPCellId-r10 | CHOICE { |
| cellGlobalId-r10 | CellGlobalIdEUTRA, |
| pci-arfcn-r10 | SEQUENCE { |
| physCellId-r10 | PhysCellId, |
| carrierFreq-r10 | ARFCN-ValueEUTRA |

}

| } | | OPTIONAL, |
|---|---|---|
| reestablishmentCellId-r10 | CellGlobalIdEUTRA | OPTIONAL, |
| timeConnFailure-r10 | INTEGER (0..1023) | OPTIONAL, |
| connectionFailureType-r10 | ENUMERATED {rlf, hof} | OPTIONAL, |
| previousPCellId-r10 | CellGlobalIdEUTRA | OPTIONAL |

]],

| | |
|---|---|
| [[ failedPCellId-v1090 | SEQUENCE { |
| carrierFreq-v1090 | ARFCN-ValueEUTRA-v9c0 |

| | |
|---|---|
| } | OPTIONAL |

]],

| | |
|---|---|
| [[ basicFields-r11 | SEQUENCE { |
| C-RNTI-r11 | C-RNTI, |
| rlf-Cause-r11 | ENUMERATED { |
| | t310-Expiry, randomAccessProblem, |
| | rlc-MaxNumRetx, t312-Expiry-r12}, |
| timeSinceFailure-r11 | TimeSinceFailure-r11 |

| | |
|---|---|
| } | OPTIONAL, |

| | |
|---|---|
| previousUTRA-CellId-r11 | SEQUENCE { |
| carrierFreq-r11 | ARFCN-ValueUTRA, |
| physCellId-r11 | CHOICE { |
| fdd-r11 | PhysCellIdUTRA-FDD, |
| tdd-r11 | PhysCellIdUTRA-TDD |

},

| | | |
|---|---|---|
| cellGlobalId-r11 | CellGlobalIdUTRA | OPTIONAL |

| | |
|---|---|
| } | OPTTONAL, |

| | |
|---|---|
| selectedUTRA-CellId-r11 | SEQUENCE { |
| carrierFreq-r11 | ARFCN-ValueUTRA, |
| physCellId-r11 | CHOICE { |
| fdd-r11 | PhysCellIdUTRA-FDD, |
| tdd-r11 | PhysCellIdUTRA-TDD |

}

| | |
|---|---|
| } | OPTIONAL |

]],

| [[ failedPCellId-v1250 | SEQUENCE { | |
|---|---|---|
| tac-FailedPCell-r12 | TrackingAreaCode | |
| } | | OPTIONAL, |
| measResultLastServCell-v1250 | RSRQ-Range-v1250 | OPTIONAL, |
| lastServCellRSRQ-Type-r12 | RSRQ-Type-r12 | OPTIONAL, |
| measResultListEUTRA-v1250 | MeasResultList2EUTRA-v1250 | OPTIONAL |

]],

| | | |
|---|---|---|
| [[ drb-EstablishedWithQCI-1-r13 | ENUMERATED {qci1} | OPTIONAL |

]],

| | | |
|---|---|---|
| [[ measResultLastServCell-v1360 | RSRP-Range-v1360 | OPTIONAL |

]],

| | | |
|---|---|---|
| [[ logMeasResultListBT-r15 | LogMeasResultListBT-r15 | OPTIONAL, |
| logMeasResultListWLAN-r15 | LogMeasResultListWLAN-r15 | OPTIONAL |

]],

| | | |
|---|---|---|
| [[ measResultListNR-r16 | MeasResultCellListNR-r15 | OPTIONAL, |
| previousNR-PCellId-r16 | CellGlobalIdNR-r16 | OPTIONAL, |

| | |
|---|---|
| failedNR-PCellId-r16 | CHOICE { |
| cellGlobalId | CellGlobalIdNR-r16, |
| pci-arfcn | SEQUENCE { |
| physCellId-r16 | PhysCellIdNR-r15, |
| carrierFreq-r16 | ARFCN-ValueNR-r15 |

| | |
|---|---|
| } | OPTIONAL, |

}

| reconnectCellId-r16 | CHOICE { | |
|---|---|---|
| nrReconnectCellId | CellGlobalIdNR-r16, | |
| eutraReconnectCellId | SEQUENCE { | |
| cellGlobalId-r16 | CellGlobalIdEUTRA, | |
| trackingAreaCode-EPC-r16 | TrackingAreaCode | OPTIONAL, |
| trackingAreaCode-5GC-r16 | TrackingAreaCode-5GC-r15 | OPTIONAL |

}

| } | | OPTIONAL, |
|---|---|---|
| timeUntilReconnection-r16 | TimeUntilReconnection-r16 | OPTIONAL |

]],

| [[ measResultListNR-v1640 | SEQUENCE { | |
|---|---|---|
| carrierFreqNR-r16 | ARFCN-ValueNR-r15 | |
| } | | OPTIONAL, |
| measResultListExtNR-r16 | MeasResultFreqListNR-r16 | OPTIONAL |

]],

| | |
|---|---|
| [[ rlf-Cause-r18 | ENUMERATED {t318-UnableAcquireSIB} |

]]
}

| | |
|---|---|
| RLF-Report-v9e0 ::= | SEQUENCE { |
| measResultListEUTRA-v9e0 | MeasResultList2EUTRA-v9e0 |

}

. . .

-- ASN1STOP

### Example Based on 3GPP TS 36.331 V17.4.0

### Example 4

### Example Based on 3GPP TS 36.331 V17.4.0

5.3.18 T317 expiry

The UE shall:
1> if in RRC_CONNECTED:
2> inform lower layers that the UL synchronisation is lost;
2> for a UE capable of NTN neighbour cell measurements:
3> start timer T319;
3> acquire SystemInformationBlockType31 (SystemInformationBlockType31-NB in NB-IoT) and SystemInformationBlockTypeXX (SystemInformationBlockTypeXX-NB in NB-IoT) as specified in 5.2.2;
3> upon successful acquisition of SystemInformationBlockType31 (SystemInformationBlockType31-NB in NB-IoT):
4> inform lower layers when UL synchronisation is restored.
3> upon successful acquisition of SystemInformationBlockType31 (SystemInformationBlockType31-NB in NB-IoT) and SystemInformationBlockTypeXX (SystemInformationBlockTypeXX-NB in NB-IoT):
4> stop timer T319;
2> else:
3> start timer T318;
3> acquire SystemInformationBlockType31 (SystemInformationBlockType31-NB in NB-IoT) as specified in 5.2.2;
3> upon successful acquisition of SystemInformationBlockType31 (SystemInformationBlockType31-NB in NB-IoT):
4> stop timer T318;
4> inform lower layers when UL synchronisation is restored.

NOTE 1: SystemInformationBlockType31 (SystemInformationBlockType31-NB in NB-IoT) may be broadcast on a different narrowband or different NB-IoT carrier than the one configured to the UE.

NOTE 2: The exact time when UL synchronisation is restored (after SystemInformationBlockType31 or SystemInformationBlockType31-NB in NB-IoT is acquired) is left to UE implementation, which can be from the subframe indicated by epochTime and optionally before the subframe indicated by epochTime.

### Example Based on 3GPP TS 36.331 V17.4.0

7.3 Timers
7.3.1 Timers (Informative)

| | | | |
|---|---|---|---|
| Timer | Start | Stop | At expiry |

. . .

| | | | |
|---|---|---|---|
| T317 | Start or restart from the | Stop T317, if it is running, | Perform the actions as specified in |
| NOTE1 | subframe indicated by | for the source cell upon | 5.3.18. |
| | epochTime upon reception of | reception of | |
| | SystemInformationBlockType31, | RRCConnectionReconfiguration | |
| | or upon reception of | message including | |
| | RRCConnectionReconfiguration | mobilityControlInfo, or | |
| | message for the target | upon conditional | |
| | cell including | reconfiguration execution | |
| | mobilityControlInfo, or upon | i.e. when applying a stored | |
| | conditional reconfiguration | RRCConnectionReconfiguration | |
| | execution i.e. when applying | message including | |
| | a stored | mobilityControlInfo. | |
| | RRCConnectionReconfiguration | | |
| | message for the target | | |
| | cell including | | |
| | mobilityControlInfo. | | |
| T318 | Upon starting acquisition of | Upon successful | If security is not activated and the |
| NOTE1 | SystemInformationBlockType31 | acquisition of | UE is not a NB-IoT UE that supports |
| | in RRC_CONNECTED | SystemInformationBlockType31in | RRC connection re-establishment |
| | | RRC_CONNECTED | for the Control Plane CIoT EPS |
| | | | optimisation: go to RRC_IDLE else: |
| | | | initiate the connection re- |
| | | | establishment procedure as |
| | | | specified in 5.3.7. |
| T319 | Upon starting acquisition of | Upon successful | Perform the following actions if |
| | SystemInformationBlockType31 | acquisition of | SystemInformationBlockType31 has |
| | in RRC_CONNECTED | SystemInformationBlockType31 | not been acquired: if security is not |
| | | and | activated and the UE is not a NB- |
| | | SystemInformationBlockTypeXX | IoT UE that supports RRC |
| | | in RRC_CONNECTED | connection re-establishment for the |
| | | | Control Plane CIoT EPS |
| | | | optimisation: go to RRC_IDLE else: |
| | | | initiate the connection re- |
| | | | establishment procedure as |
| | | | specified in 5.3.7. |

### Example Based on 3GPP TS 36.331 V17.4.0

FIG. 11 is a block diagram of an exemplary network entity that may be used in examples of the present disclosure. For example, a UE and/or gNB in the examples of FIGS. 1-10 may comprise an entity of FIG. 11. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 1100 comprises a processor (or controller) 1101, a transmitter 1103 and a receiver 1105. The receiver 1105 is configured for receiving one or more messages from one or more other network entities, for example as described above. The transmitter 1103 is configured for transmitting one or more messages to one or more other network entities, for example as described above. The processor 1101 is configured for performing one or more operations, for example according to the operations as described above.

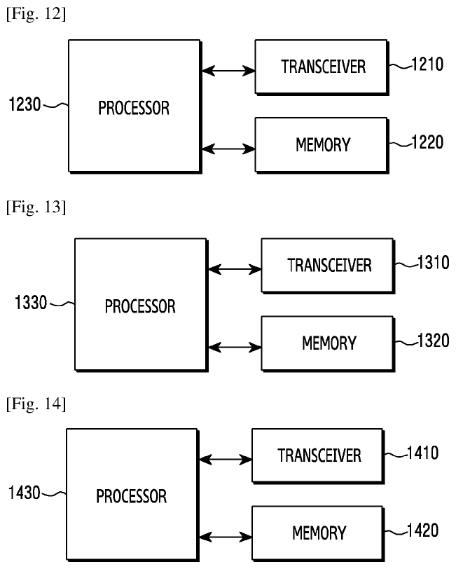

FIG. 12 illustrates a block diagram of a terminal (or a user equipment (UE)), according to embodiments of the present disclosure. FIG. 12 corresponds to the example of the UE of FIG. 1.

As shown in FIG. 12, the UE according to an embodiment may include a transceiver 1210, a memory 1220, and a processor 1230. The transceiver 1210, the memory 1220, and the processor 1230 of the UE may operate according to a communication method of the UE described above. However, the components of the UE are not limited thereto. For example, the UE may include more or fewer components than those described above. In addition, the processor 1230, the transceiver 1210, and the memory 1220 may be implemented as a single chip. Also, the processor 1230 may include at least one processor.

The transceiver 1210 collectively refers to a UE receiver and a UE transmitter, and may transmit/receive a signal to/from a base station or a network entity. The signal transmitted or received to or from the base station or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the UE. Also, the memory 1220 may store control information or data included in a signal obtained by the UE. The memory 1220 may be a storage medium, such as read-only memory (ROM), random access memory (RAM), a hard disk, a CD-ROM, and a DVD, or a combination of storage media.

The processor 1230 may control a series of processes such that the UE operates as described above. For example, the transceiver 1210 may receive a data signal including a control signal transmitted by the base station or the network entity, and the processor 1230 may determine a result of receiving the control signal and the data signal transmitted by the base station or the network entity.

FIG. 13 illustrates a block diagram of a base station, according to embodiments of the present disclosure. FIG. 13 corresponds to the example of the RAN node of FIG. 1.

As shown in FIG. 13, the base station according to an embodiment may include a transceiver 1310, a memory 1320, and a processor 1330. The transceiver 1310, the memory 1320, and the processor 1330 of the base station may operate according to a communication method of the base station described above. However, the components of the base station are not limited thereto. For example, the base station may include more or fewer components than those described above. In addition, the processor 1330, the transceiver 1310, and the memory 1320 may be implemented as a single chip. Also, the processor 1330 may include at least one processor.

The transceiver 1310 collectively refers to a base station receiver and a base station transmitter, and may transmit/receive a signal to/from a terminal or a network entity. The signal transmitted or received to or from the terminal or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the base station. Also, the memory 1320 may store control information or data included in a signal obtained by the base station. The memory 1320 may be a storage medium, such as read-only memory (ROM), random access memory (RAM), a hard disk, a CD-ROM, and a DVD, or a combination of storage media.

The processor 1330 may control a series of processes such that the base station operates as described above. For example, the transceiver 1310 may receive a data signal including a control signal transmitted by the terminal, and the processor 1330 may determine a result of receiving the control signal and the data signal transmitted by the terminal.

FIG. 14 illustrates a block diagram of a network entity, according to embodiments of the present disclosure. FIG. 14 corresponds to the example of the core network entity of FIG. 1.

As shown in FIG. 14, the network entity according to an embodiment may include a transceiver 1410, a memory 1420, and a processor 1430. The transceiver 1410, the memory 1420, and the processor 1430 of the network entity may operate according to a communication method of the network entity described above. However, the components of the network entity are not limited thereto. For example, the network entity may include more or fewer components than those described above. In addition, the processor 1430, the transceiver 1410, and the memory 1420 may be implemented as a single chip. Also, the processor 1430 may include at least one processor.

The transceiver 1410 collectively refers to a network entity receiver and a network entity transmitter, and may transmit/receive a signal to/from a terminal or other network entity. The signal transmitted or received to or from the terminal or other network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the network entity. Also, the memory 1420 may store control information or data included in a signal obtained by the network entity. The memory 1420 may be a storage medium, such as read-only memory (ROM), random access memory (RAM), a hard disk, a CD-ROM, and a DVD, or a combination of storage media.

The processor 1430 may control a series of processes such that the network entity operates as described above. For example, the transceiver 1410 may receive a data signal including a control signal transmitted by the terminal, and the processor 1430 may determine a result of receiving the control signal and the data signal transmitted by the terminal.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

1. A method performed by a user equipment (UE) in a wireless communication system, the method comprising:
identifying an expiration of a second timer;
informing, to a lower layer, a loss of an uplink synchronization and starting a first timer based on the expiration of the second timer;
receiving, from a base station (BS), a first system information block (SIB) associated with satellite information for a non-terrestrial network (NTN) cell;
identifying that a second SIB associated with satellite information for a neighbor cell is received from the BS; and
in case that the second SIB is received, stopping the first timer.

2. The method of claim 1,
wherein, in case that the first SIB and the second SIB are received while the first timer is running, the first timer is stopped.

3. The method of claim 1,
wherein a radio link failure (RLF) is detected, in case that the first timer expires and the first SIB is not received.

4. The method of claim 1,
wherein a validity duration for the second SIB is configured.

5. A method performed by a base station (BS) in a wireless communication system, the method comprising:
transmitting, to a user equipment (UE), a first system information block (SIB) associated with satellite information for a non-terrestrial network (NTN) cell;
transmitting, to the UE, a second SIB associated with satellite information for a neighbor cell,
wherein a first timer associated with the first SIB and the second SIB is started based on an expiration of a second timer.

6. The method of claim 5,
wherein, in case that the first SIB and the second SIB are received while the first timer is running, the first timer is stopped.

7. The method of claim 5,
wherein a validity duration for the second SIB is configured.

8. A user equipment (UE) in a wireless communication system, the UE comprising:
a transceiver, and
a controller coupled with the transceiver and configured to:
identify an expiration of a second timer;
inform, to a lower layer, a loss of an uplink synchronization and start a first timer based on the expiration of the second timer;
receive, from a base station (BS), a first system information block (SIB) associated with satellite information for a non-terrestrial network (NTN) cell;
identify that a second SIB associated with satellite information for a neighbor cell is received from the BS;
in case that the second SIB is received, stop the first timer.

9. The UE of claim 8,
wherein, in case that the first SIB and the second SIB are received while the first timer is running, the first timer is stopped.

10. The UE of claim 8,
wherein a radio link failure (RLF) is detected, in case that the first timer expires and the first SIB is not received.

11. The UE of claim 9,
wherein a validity duration for the second SIB is configured.

12. A base station (BS) in a wireless communication system, the BS comprising:
a transceiver, and
a controller coupled with the transceiver and configured to:
transmit, to a user equipment (UE), a first system information block (SIB) associated with satellite information for a non-terrestrial network (NTN) cell;
transmit, to the UE, a second SIB associated with satellite information for a neighbor cell,
wherein a first timer associated with the first SIB and the second SIB is started based on an expiration of a second timer.

13. The BS of claim 12,
wherein, in case that the first SIB and the second SIB are received while the first timer is running, the first timer is stopped.

14. The BS of claim 12,
wherein a validity duration for the second SIB is configured.
